(19) United States
(12) Patent Application Publication
(10) Pub. No.: US 2009/0152752 A1
(43) Pub. Date: Jun. 18, 2009

(54) Method of Forming Crash Panel for Vehicles

(75) Inventor: Seung Sik HAN, Hwaseong-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corp., Seoul (KR)

(21) Appl. No.: 12/323,460

(22) Filed: Nov. 25, 2008

(30) Foreign Application Priority Data
Dec. 14, 2007 (KR) 10-2007-0131014

(51) Int. Cl. B29C 45/77

(52) U.S. Cl. 264/40.3

(57) ABSTRACT

Disclosed herein is a method of forming a crash panel for vehicles, which prevents a tear line from discoloring, prevents sink marks from occurring, and additionally has a reduced manufacturing cost. The method includes injecting and charging molten resin into a mold having a core and a cavity so as to form a crash panel integrated with an airbag door through injection molding, maintaining a pressure acting on the resin in the mold constant, in addition to preventing backflow of the charged resin, adjusting a section using an air nozzle so as to determine a section of a tear line at which the crash panel is separated from the airbag door, blowing air through the air nozzle which is inserted into an air path defined in the core, thus controlling a thickness of the tear line, and cooling the molten resin.

### CROSS-REFERENCE TO RELATED APPLICATION

The present application claims priority to Korean Application No. 10-2007-0131014 filed Dec. 14, 2007, the entire contents of which application is incorporated herein for all purposes by this reference.

### BACKGROUND OF THE INVENTION

1. Field of the Invention

The present invention relates to a crash panel having a tear line along which an airbag door ruptures in the event of a vehicle crash, and a method of forming the crash panel and, more particularly, to a method of forming a crash panel for vehicles, in which an airbag door and a crash panel are injection molded using an integrated core, and the thickness of a tear line of the crash panel is adjusted through an air blowing step, thus preventing the tear line from discoloring, and preventing sink marks from occurring, in addition to reducing manufacturing costs.

2. Description of Related Art

Generally, a crash panel is mounted to the front of a vehicle, where a steering wheel and instruments are located.

The crash panel is usually manufactured by injecting one kind of synthetic resin into a mold. Currently, an airbag is additionally mounted adjacent a passenger seat in the vehicle. An airbag door is provided on a portion of the crash panel accommodating the airbag for the passenger seat, and is defined by a separating line which is formed using a laser so as to permit inflation of the airbag. Recently, the crash panel is manufactured through a two-shot molding method which simultaneously injects two kinds of resins. Through the two-shot molding method, a part in which the airbag for the passenger seat is mounted and a tear line are manufactured of a material having high softness, thus allowing the airbag door to be more easily opened.

FIG. 1a illustrates a conventional crash panel 10 which is manufactured through the two-shot molding method.

An airbag door 20 and a crash panel 10 having a tear line 12 which serves to separate the airbag door 20 from a surrounding part are made of different resins so as to easily open the airbag door 20. To this end, the two-shot molding method is used.

Generally, the crash panel 10 is mainly made of PPF (PolyPropylene Fiber) resin having high rigidity, while the airbag door 20 is mainly made of TPO (ThermoPlastic Olefin) resin or TPE (ThermoPlastic Elastomer) resin having high softness.

However, the conventional two-shot molding method is problematic in that different kinds of resins are used, so that the tear line discolors and thus provides a unsightly appearance, and sink marks occur.

In order to overcome the problem, a laser scoring method is used, as shown in FIG. 1b. The method prevents the tear line 12 from discoloring. However, since the tear line 12 of the crash panel 10 is formed through a laser process, an additional process is required, and thus the manufacturing cost is increased.

Meanwhile, as the method of forming the crash panel 10, an in-situ molding method may be used, as shown in FIG. 1c. According to this method, a notched protrusion is provided in a core 40 so that the tear line 12 is formed in an injection product. However, the method is problematic in that the mold structure is complex, and sink marks may occur due to a sudden change in the thickness of the tear line 12.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Accordingly, various aspects of the present invention have been developed to overcome the above problems. Various aspects of the present invention provide for a new method of forming a crash panel for vehicles and a crash panel manufactured through the method, which prevent a tear line from discoloring, and prevent sink marks from occurring, in addition to preventing manufacturing costs from increasing due to a complicated mold structure.

One aspect of the present invention is directed to a method of forming a crash panel for vehicles. The method may include injecting and charging molten resin into a mold having a core and a cavity so as to form a crash panel integrated with an airbag door through injection molding,

maintaining constant pressure on the resin in the mold constant, in addition to preventing backflow of the charged resin, adjusting an air nozzle so as to form a cross-section of a tear line at which the crash panel is separated from the airbag door, blowing air through the air nozzle which is inserted into an air path defined in the core, thus controlling a thickness of the tear line, and/or cooling the molten resin.

The method may further include measuring a temperature of the molten resin before blowing the air.

The blowing the air step may further include sensing a pressure of the introduced air.

The blowing the air step may further include sensing a pressure of the introduced air.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1a is a schematic view showing a conventional crash panel for vehicles manufactured through a two-shot molding method.

FIG. 1b is a schematic view showing another conventional crash panel for vehicles manufactured through a laser scoring method.

FIG. 1c is a schematic view showing a conventional in-situ molding method of forming a crash panel for vehicles.

FIG. 2 is a schematic view showing an exemplary crash panel for vehicles according to the present invention.

FIGS. 3a to 3c are schematic views showing respective steps of an exemplary method of forming the crash panel for vehicles according to the present invention.

FIG. 4a is a schematic view showing an exemplary temperature sensing step and pressure sensing step of the forming method according to the present invention.

FIG. 4b is a schematic view showing the thickness of an exemplary tear line of the crash panel for vehicles according to the present invention.

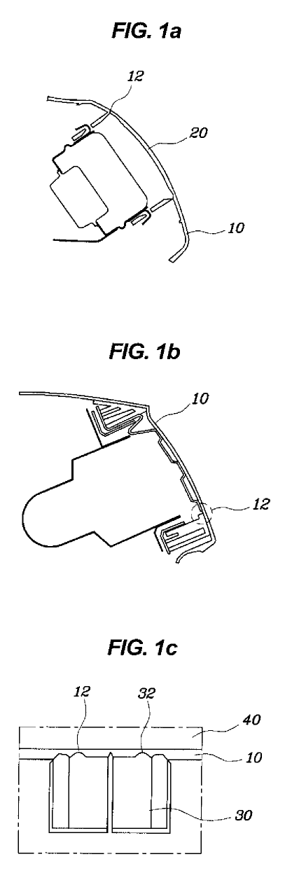

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

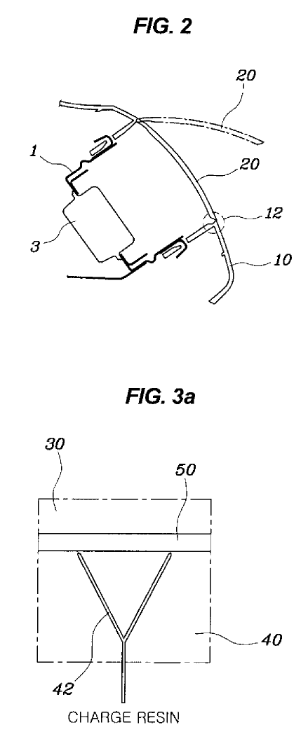

As shown in FIG. 2, an airbag 3 is mounted to a vehicle in such a way as to be accommodated in a housing 1. The housing 1 is covered with an airbag door 20. A tear line 12 is provided at a predetermined position on the airbag door 20 of a crash panel 10. The thickness of the section of the tear line 12 is reduced, so that the airbag door 20 is more easily broken than the crash panel 10 during a vehicle collision. Thus, when vehicle impact occurs, the tear line 12 is broken, so that the airbag door 20 is opened, and an airbag 3 installed in the housing 1 is inflated, thus protecting a passenger.

In order to produce the crash panel 10 and the airbag door 20, an injection molding method may be used.

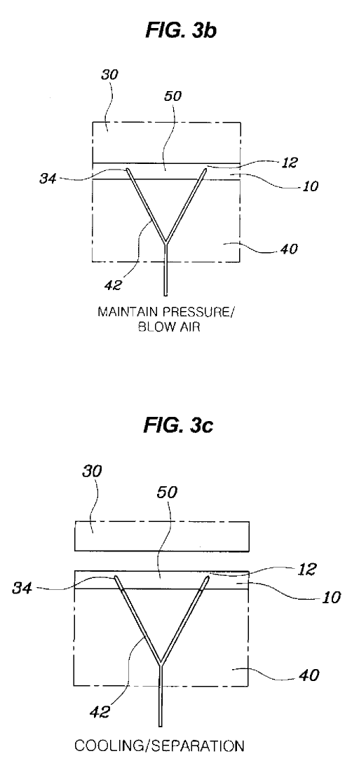

As shown in FIG. 3a, an air path 42 is formed in a core 40 of the crash panel 10 which is integrated with the airbag door 20 of the vehicle, so that air is introduced into the air path 42.

In order to manufacture the crash panel 10, molten resin 50 enters a mold including the core 40 and a cavity 30. In this state, pressure acts on the resin 50 in the mold.

As shown in FIG. 3b, in order to prevent the charged resin from flowing backwards and to obtain an injection product having a desired shape, a pressure maintaining step is performed. At this step, pressure is applied to the resin 50 in the mold, and pressure sufficient to form the shape of the crash panel 10 is maintained constant.

After the pressure maintaining step has been completed, a section adjusting step using an air nozzle is conducted. At this step, an air nozzle 34, which has a cross-section of a desired size to form the tear line, is inserted into the air path 42 which is formed in the core 40, thus determining the shape of the section of the tear line 12.

At the section adjusting step, the shape of the section of the tear line 12, which is broken when an impact exceeds a predetermined level, is determined.

After the section adjusting step has been completed, an air blowing step is performed. At this step, the air nozzle 34 is inserted into the air path 42 to blow air into the air path 42. Through the air blowing step, the thickness t of the tear line 12 formed on the crash panel 10 can be adjusted.

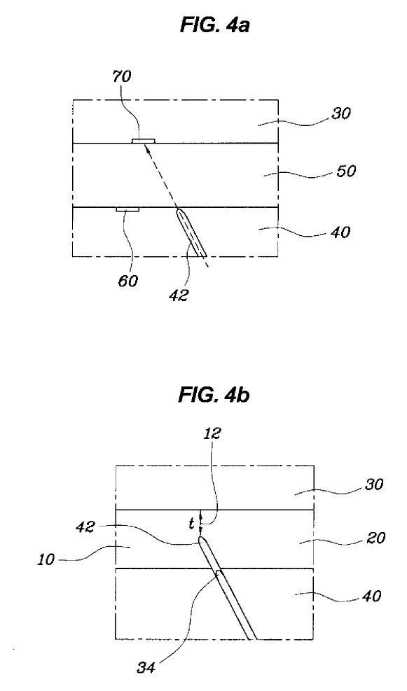

As shown in FIG. 4a, preferably, the method of forming the crash panel for vehicles further includes a temperature sensing step and a pressure sensing step. The temperature sensing step measures the temperature of the molten resin 50 before the air blowing step. The pressure sensing step measures the pressure of air that flows through the air path 42 at the air blowing step.

In order to adjust the thickness of the section of the tear line 12 of the crash panel 10, air must be introduced before the resin therein is cooled. Thus, in order to easily form a tearing line, the temperature of the resin 50 is measured using a temperature sensor 60. Afterwards, the air blowing step is performed at a temperature suitable for the introduction of air.

Further, according to the pressure of air introduced into the air path 42 at the air blowing step, the thickness of the tear line 12 is determined. Thus, in order to introduce air having proper pressure, it is preferable that the pressure of the air be measured and controlled using a pressure sensor 70.

As shown in FIG. 4b, after the above-mentioned steps of forming the crash panel have been performed, the crash panel 10 has a tear line 12 having a predetermined thickness t, by air which is supplied from the air nozzle 34 inserted into the air path 42 during the injection molding process. Therefore, the airbag door 20 is provided on the crash panel 10 along the tear line 12.

As described above, the present invention provides a method of forming a crash panel for vehicles, which prevents a tear line from discoloring, and prevents sink marks from occurring, and additionally has a reduced manufacturing cost.

For convenience in explanation and accurate definition in the appended claims, the terms “upper” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of forming a crash panel for vehicles, comprising:
injecting and charging molten resin into a mold having a core and a cavity so as to form a crash panel integrated with an airbag door through injection molding;
maintaining constant pressure on the resin in the mold constant, in addition to preventing backflow of the charged resin;
adjusting an air nozzle so as to form a cross-section of a tear line at which the crash panel is separated from the airbag door;
blowing air through the air nozzle which is inserted into an air path defined in the core, thus controlling a thickness of the tear line; and
cooling the molten resin.

2. The method as set forth in claim 1, further comprising:
measuring a temperature of the molten resin before blowing air.

3. The method as set forth in claim 1, wherein the blowing air step further comprises:
sensing a pressure of the introduced air.

4. The method as set forth in claim 2, wherein the blowing air step further comprises:
sensing a pressure of the introduced air.
